(19) United States
(12) Patent Application Publication
(10) Pub. No.: US 2015/0113210 A1
(43) Pub. Date: Apr. 23, 2015

(54) DATA STORAGE FLASH MEMORY MANAGEMENT METHOD AND PROGRAM

(71) Applicant: Renesas Electronics Corporation, Kawasaki-shi (JP)

(72) Inventors: Shinichi SUZUKI, Kanagawa (JP); Ryosuke YAMAUCHI, Tokyo (JP)

(73) Assignee: RENESAS ELECTRONICS CORPORATION, Kawasaki-shi (JP)

(21) Appl. No.: 14/509,142

(22) Filed: Oct. 8, 2014

(30) Foreign Application Priority Data
Oct. 22, 2013 (JP) 2013-219084

(51) Int. Cl. G06F 12/02

(52) U.S. Cl. CPC G06F 12/0246; G06F 2212/7204
USPC 711/103

(57) ABSTRACT

There is provided a data storage flash memory management method that does not require a management area and can reduce an access load. A data storage flash memory management method for storing k time-varying parameters (k is a positive integer) in a flash memory including j blocks (j is an even number not less than 2) as erase units is configured as follows. The j blocks are divided into two areas which are a primary macroblock and a secondary macroblock, each including j/2 blocks. Each of the primary macroblock and the secondary macroblock is divided into k or more segments each having an equal memory capacity, with one of the macroblocks as an active system and the other as a standby system. The k parameters are one-to-one associated with k segments of the k or more segments, and each parameter is written or read to/from a corresponding segment in an active-system macroblock.

### CROSS-REFERENCE TO RELATED APPLICATIONS

The disclosure of Japanese Patent Application No. 2013-219084 filed on Oct. 22, 2013 including the specification, drawings and abstract is incorporated herein by reference in its entirety.

### BACKGROUND

The present invention relates to a data storage flash memory management method and a program thereof, and is particularly suited to reduce a load of access to a flash memory.

Industrial equipment such as robots and machine tools uses various kinds of parameters representing the numbers of revolutions, angles, positions to calculate control instruction values and state values. Further, communication equipment such as cell phones and servers uses parameters such as correspondent IP (Internet Protocol) addresses and vendor IDs (Identifications) in TCP/IP (Transmission Control Protocol/Internet Protocol) and USB (Universal Serial Bus) communication. When the equipment is stopped (powered off) and activated again, these parameters are used again. Therefore, it is necessary to store these parameters in a nonvolatile memory. Further, reading is performed frequently, and though not so frequently as reading, some parameters change with time, which requires the update of values. There is greatly used a flash memory as the nonvolatile memory for the equipment, and there is used a flash memory called a data flash mounted over the same semiconductor chip as a CPU (Central Processing Unit) and used to store data such as the above-described parameters.

In the flash memory, an area of several kilobytes (KB) called a block can be erased collectively as one unit. A write unit is several bytes (B). An address area where writing has been performed cannot be overwritten with another value, and rewriting can be performed only after values are erased in units of blocks. In the flash memory for storing the above-described parameters, a method for adding an updated value (latest value) to a new address area to update the value of a stored parameter is generally adopted. Accordingly, there are proposed various management methods for obtaining an address where the latest value is stored at the time of reading a parameter from the flash memory.

Japanese Unexamined Patent Publication No. 2013-3655 (Patent Document 1) discloses a microcontroller incorporating a flash memory. A plurality of blocks configuring the incorporated flash memory are divided into one management block and a plurality of blocks belonging to any of a plurality of areas. The “areas” are provided to assort the destination of a record in the flash memory in accordance with the type of data contained in the record. Information indicating the correspondence between the type of data and a record area, that is, an area correspondence table indicating the correspondence relationship between a data ID and an area is stored in a ROM separated from the flash memory (paragraphs [0017] to [0018]). Further, information about a block where the latest value of data is recorded in each area is written in the management block (paragraph [0022]). A CPU incorporated in the microcontroller refers to the information recorded in the management block and the area correspondence table, and reads desired data, adds data, or erases data in units of blocks.

Japanese Unexamined Patent Publication No. Hei 11(1999)-353241 (Patent Document 2) discloses a data backup method using a nonvolatile memory such as a flash memory. A write area for the same type of data is provided on each of two memory media. When data on one memory medium is erased, input data is written to the other memory medium. The operation status of each memory medium is managed using a management data storage area provided on each memory medium. The write area according to the type of data is assigned one or a plurality of blocks (called sectors in Patent Document 2) as erase units.

### SUMMARY

The present inventors have examined Patent Documents 1 and 2 and found the following problem.

In the case where a time-varying parameter for control or communication is stored in the flash memory of nonvolatility for power-off of the equipment, the use of the above related arts requires an access device such as a CPU and a memory controller to be heavily loaded in parameter access. Since the flash memory includes a plurality of blocks as erase units and the erase unit (several KB) is significantly larger than the write unit (several B) as described above, data access is managed using a provided management area of some kind. In Patent Document 1, the management block is provided in the flash memory, and the area correspondence table indicating the correspondence relationship between the data ID and the area is stored in the ROM separated from the flash memory. In Patent Document 2, the management data storage area is provided. At the time of reading desired data, the access device first accesses the management area, identifies a block where the data is stored, searches the block, and reads the latest (last updated) data. When data changes and needs to be written, the access device accesses the management area, identifies a block where the data is to be added, searches for an unused area (blank area) in the block, and writes the data.

As described above, the access device such as the CPU and the memory controller has to first access the management area, identify a block to be searched, and search the identified block, that is, take several access steps, and accordingly is heavily loaded in access.

While means for solving these problems will be described below, the other problems and novel features will become apparent from the description of this specification and the accompanying drawings.

One embodiment will be briefly described as follows.

A data storage flash memory management method for storing k types of (or k) time-varying parameters (k is a positive integer) in a flash memory including j blocks (j is an even number not less than 2) as erase units is configured as follows.

The method includes the steps of dividing the j blocks into two areas which are a primary macroblock and a secondary macroblock, each including j/2 blocks; dividing each of the primary macroblock and the secondary macroblock into k or more segments each having an equal memory capacity, with one of the macroblocks as an active system and the other as a standby system; one-to-one associating the k parameters with k segments of the k or more segments; and writing or reading each parameter to/from a corresponding segment in an active-system macroblock.

An effect obtained by the one embodiment will be briefly described as follows.

It is not necessary to provide a management area in the flash memory and the step of accessing the management area in access, which can reduce an access load.

### BRIEF DESCRIPTION OF THE DRAWINGS

FIG. 1 is an explanation diagram showing a data configuration on a data storage flash memory (data flash).

FIG. 2 is an explanation diagram showing the configuration of a record on the data flash.

FIG. 3 is an explanation diagram showing the configuration of a header.

FIG. 4 is an explanation diagram showing a configuration example of a system to which the data flash is applied.

FIG. 5 is an explanation diagram showing a configuration example of software and the data flash in the system.

FIG. 6 is a flowchart (first half) showing an operation for writing a parameter to the data flash.

FIG. 7 is a flowchart (latter half) showing the operation for writing the parameter to the data flash.

FIG. 8 is an explanation diagram showing the operation for writing the parameter to the data flash (without concatenation).

FIG. 9 is an explanation diagram showing the contents of a record (M, N) in FIG. 8.

FIG. 10 is an explanation diagram showing the operation for writing the parameter to the data flash (with concatenation).

FIG. 11 is an explanation diagram showing the contents of the record (M, N+1) and the record (M, N+2) in FIG. 10.

FIG. 12 is an explanation diagram showing an operation in the case where block erasing occurs by writing the parameter to the data flash.

FIG. 13 is an explanation diagram showing the contents of the record (M, N+1) in FIG. 12.

FIG. 14 is an explanation diagram showing an operation for switching between the active system and the standby system of primary and secondary macroblocks.

FIG. 15 is an explanation diagram showing a transfer operation of the latest record in the switching operation.

FIG. 16 is a flowchart showing an operation for reading the parameter from the data flash.

FIG. 17 is an explanation diagram showing the configuration of a conversion table on the data flash according to a second embodiment.

FIG. 18 is a flowchart showing a write operation to the data flash according to the second embodiment.

FIG. 19 is a flowchart showing a read operation from the data flash according to the second embodiment.

FIG. 20 is an explanation diagram showing the configuration of the conversion table on the data flash according to a third embodiment.

### DETAILED DESCRIPTION

### 1. Outline of Embodiments

First, exemplary embodiments of the invention disclosed in the present application will be outlined. Reference numerals in the drawings that refer to with parentheses applied thereto in the outline description of the exemplary embodiments are merely illustration of ones contained in the concepts of components marked with the reference numerals.

[1]<One-to-One Association of Parameter with Segment>

A data storage flash memory management method for storing k (or k types of) varying parameters (k is a positive integer) in a flash memory (1) including j blocks (3) (j is an even number not less than 2) as erase units is configured as follows.

In the flash memory, the j blocks are divided into two areas which are a primary macroblock (2_1) and a secondary macroblock (2_2), each including j/2 blocks.

Each of the primary macroblock and the secondary macroblock is divided into k or more segments (4) each having an equal memory capacity, with one of the macroblocks as an active system and the other as a standby system.

The k parameters (5) are one-to-one associated with k segments of the k or more segments, and each parameter is written or read to/from a corresponding segment in an active-system macroblock.

Thereby, it is not necessary to provide a management area in the flash memory and the step of accessing the management area in access, which can reduce an access load.

[2]<Record=Header (Number of Divisions, Offset, Etc.)+Data>

In item 1, an Mth parameter (M is a positive integer not more than k) included in the k parameters is written from a start address of an Mth segment in the active-system macroblock, with header information (10) added to the Mth parameter (S7), and the Mth parameter is written from a start address of a blank area of the Mth segment at the time of subsequently writing the Mth parameter (S14).

The header information includes the number of segments (15) included in each of the primary macroblock and the secondary macroblock and address offset information (16) for calculating a start address of an area where the Mth parameter is to be written next.

Thereby, it is possible to easily calculate the start address of the blank area.

[3]<Writing to Blank Segment at the Time of No Space in Corresponding Segment>

In item 1 or 2, the number of segments included in each of the primary macroblock and the secondary macroblock is equal to or more than k+1. All or part of a value of an Mth parameter included in the k parameters is written to a segment other than first to kth segments in the active-system macroblock if there remains no writable area in an Mth segment to write the Mth parameter to the corresponding Mth segment in the active-system macroblock (S16-S20).

Address offset information (16) included in header information of the Mth parameter includes information indicating a start address of the writable segment as an area where the Mth parameter is to be written next.

Thereby, if there is no space in the corresponding segment, it is possible to search for an unused segment and use it as a new writable segment. Further, the selected segment to which the next Mth parameter is to be written can be easily calculated from the header information of data last written in the Mth segment.

[4]<Switching Between Macroblocks at the Time of No Blank Segment>

In item 3, the Mth parameter is written from a start address of the Mth segment in the standby-system macroblock if there remains no unused segment in the active-system macroblock to write the Mth parameter (S21).

Then, the latest values of parameters other than the Mth parameter are read from the active-system macroblock and the latest values are written to corresponding segments in the standby-system macroblock (S23-S28).

Then, data in all areas of the active-system macroblock is erased (S27).

Then, the standby-system macroblock is set to a new active-system macroblock, and the active-system macroblock is set to a new standby-system macroblock.

Thereby, it is possible to alternately switch between the active system and the standby system of the primary and secondary macroblocks.

[5]<Blank Check (at the Time of Writing)>

In item 2, the address offset information included in the header information is read from a top of the active-system macroblock at the time of writing the Mth parameter (S4).

A step for calculating a start address of an area where the Mth parameter is next updated and written based on the address offset information (S10-S11) and determining whether the area is an area where data is already written or a blank area by reading data in the area (S9-S12) is repeated until the blank area is found.

The Mth parameter is written to the found blank area (S14).

Thereby, it is possible to find the blank area in a short search time (search step) and write the parameter to the blank area.

[6]<Determination of Latest Parameter (at the Time of Reading)>

In item 2, the address offset information included in the header information is read from a top of the active-system macroblock at the time of reading the Mth parameter (S35).

A step for calculating a start address of an area where the Mth parameter is next updated and written based on the address offset information and determining whether the area is an area where data is already written or a blank area by reading data in the area (S39-S43) is repeated until the blank area is found.

The Mth parameter written just before the found blank area is read as the latest value of the Mth parameter (S44).

Thereby, it is possible to find and read the latest parameter in a short search time (search step).

[7]<Header Includes Segment ID>

In item 2, the header information further includes segment identification information (13) of a segment where the Mth parameter is written.

Thereby, it is possible to determine the type of parameter from the header information included in read data.

[8]<Conversion Table for Associating Segment ID with Array Name>

In item 7, a conversion table (7) for associating the segment identification information with an array name used by an application program (91) is stored in the data storage flash memory.

This enables access by the array name through the application program, and makes it possible to handle data in the data storage flash memory through the application program described in a high-level language as well.

[9]<Update of Correspondence Relationship Between Segment ID and Array Name in Conversion Table>

In item 8, the array name can be associated with the same segment identification information a plurality of times in the conversion table, the association of the array name with the segment identification information is invalidated by an even-numbered association, and the association of the array name with the segment identification information is invalidated by a next odd-numbered association.

Thereby, it is possible to change the array name associated with the segment ID.

[10]<Program (One-to-One Association of Parameter with Segment)>

A program (92) for repeatedly updating and writing k time-varying parameters (k is a positive integer) to a flash memory (1) and reading the latest data of the parameters and executed by a processor (81) which can access the flash memory executes the following processes.

A primary macroblock (2_1) and a secondary macroblock (2_2) each having the same number of blocks (3) as erase units in the flash memory are defined, with one of the primary and secondary macroblocks as an active system and the other as a standby system. K or more segments (4) each having an equal memory capacity in the primary macroblock are defined and k or more segments (4) each having an equal memory capacity in the secondary macroblock are defined.

The k parameters are one-to-one associated with k segments of the k or more segments.

A write step (S4-S20) for writing a parameter to a corresponding segment in an active-system macroblock in the flash memory is executed.

A read step (S35-S45) for reading the latest value of the parameter from a corresponding segment in the active-system macroblock in the flash memory is executed.

Thereby, in a data processing device including the data storage flash memory and the processor which can access the data storage flash memory, it is not necessary to provide a management area in the flash memory and the step of accessing the management area in access, which can provide the data storage flash memory management program that can reduce the load of access by the processor.

[11]<Write Step for Searching for Blank Area and Read Step for Searching for Latest Value; Record=Header (Number of Divisions, Offset, Etc.)+Data>

In item 10, an Mth parameter (M is a positive integer not more than k) included in the k parameters is written in order from a start address of a corresponding Mth segment in the active-system macroblock, with header information (10) added to the Mth parameter.

The header information includes the number of segments (15) included in each of the primary macroblock and the secondary macroblock and address offset information (16) indicating an offset to a start of an area where the Mth parameter is to be written next.

The write step for writing the Mth parameter includes a step of reading the address offset information included in the header from the start address of the Mth segment (S4), repeating a step of calculating an address for storing next header information based on the address offset information and reading the next header information (S9-S12), until a blank area where header information is not stored is reached, and writing the Mth parameter with header information to the blank area (S14, S20).

The read step for reading the latest value of the Mth parameter includes a step of reading the address offset information included in the header from the start address of the Mth segment (S36, S39), repeating a step of calculating an address for storing next header information based on the address offset information and reading the next header information (S39-S43), until a blank area where header information is not stored is reached, and reading the parameter with header information read just before the blank area is reached, as the latest value of the Mth parameter (S44).

Thereby, it is possible to find the blank area in a short search time (search step) and write the parameter to the blank area, and to find and read the latest parameter.

[12]<Writing to Blank Segment at the Time of No Space in Corresponding Segment>

In item 11, the number of segments included in each of the primary macroblock and the secondary macroblock is equal to or more than k+1. The write step for writing the Mth parameter includes a step of writing all or part of a value of the Mth parameter included in the k parameters to a segment other than first to kth segments in the active-system macroblock if there remains no writable area in the Mth segment to write the Mth parameter to the corresponding Mth segment in the active-system macroblock (S16-S20).

The address offset information included in the header information of the Mth parameter includes information for calculating a start address of the writable segment as an area where the Mth parameter is to be written next.

Thereby, if there is no space in the corresponding segment, it is possible to search for an unused segment and use it as a new writable segment. Further, the selected segment to which the next Mth parameter is to be written can be easily calculated from the header information of data last written in the Mth segment.

[13]<Switching Between Macroblocks at the Time of No Blank Segment>

In item 12, the program includes a step (S21) of writing the Mth parameter from a start address of the Mth segment in the standby-system macroblock if there remains no unused segment in the active-system macroblock to write the Mth parameter.

After the step above, the program includes a step (S24-S25) of reading the latest values of parameters other than the Mth parameter from the active-system macroblock and writing the latest values to corresponding segments in the standby-system macroblock.

After the steps above, the program includes a step (S27) of erasing data in all areas of the active-system macroblock.

After the steps above, the program includes a step of setting the standby-system macroblock to a new active-system macroblock and setting the active-system macroblock to a new standby-system macroblock.

Thereby, it is possible to alternately switch between the active system and the standby system of the primary and secondary macroblocks.

[14]<Header Includes Segment ID>

In item 11, the header information further includes segment identification information (13) of a segment where the Mth parameter is written.

Thereby, it is possible to determine the type of parameter from the header information included in read data.

[15]<Conversion Table for Associating Segment ID with Array Name>

In item 14, the program includes a step of storing a conversion table (7) for associating the segment identification information with an array name used by an application program (91) in the flash memory.

This enables access by the array name through the application program, and makes it possible to handle data in the data storage flash memory through the application program described in a high-level language as well.

[16]<Update of Correspondence Relationship Between Segment ID and Array Name in Conversion Table>

In item 15, the program includes a step of allowing association of the array name with the same segment identification information a plurality of times in the conversion table, invalidating the association of the array name with the segment identification information by an even-numbered association, and validating the association of the array name with the segment identification information by a next odd-numbered association.

Thereby, it is possible to change the array name associated with the segment ID.

### 2. Details of Embodiments

Embodiments will be described in greater detail below.

### First Embodiment

### One-to-One Association of Parameter with Segment

FIG. 4 is an explanation diagram showing a configuration example of a system 70 to which a data storage flash memory (data flash) 1 according to the first embodiment is applied. The system 70 includes a microcomputer 80 for controlling industrial equipment 71 such as a robot and a machine tool and communication equipment 72 such as a cell phone and a server via communication means such as USB, Ethernet (registered trademark), or other serial communication. The microcomputer 80 includes a memory 83, the data flash 1, a CPU core 81, and an I/O 82. The memory 83 stores a program 90 for controlling the industrial equipment 71 and the communication equipment 72. The data flash 1 stores instruction values and state values for controlling the equipment, the numbers of revolutions, angles, positions, etc. which are control parameters used to calculate these values, and communication parameters such as correspondent IP addresses and vendor IDs in TCP/IP and USB communication. The CPU core 81 executes the program 90 read from the memory 83, and performs a control operation and communication processing based on a parameter 5 read from the data flash 1. The I/O 82 performs data input/output processing under the control of the CPU core 81 to control the industrial equipment 71 and the communication equipment 72.

Although not restricted, the microcomputer 80 is formed over a single semiconductor substrate made of e.g. silicon, using a known CMOS (Complementary Metal-Oxide-Semiconductor field effect transistor) LSI (Large Scale Integrated circuit) manufacturing technology. The data flash 1 is a flash memory formed over the same semiconductor substrate as the CPU core 81, and includes a plurality of areas as collective erase units called blocks. The flash memory has write units and read units smaller than blocks. The memory 83 is comprised of a nonvolatile memory such as an SRAM (Static Random Access Memory) or a flash memory or a combination thereof. The CPU core 81, the memory 83, the data flash 1, the I/O 82, etc. may all be formed over the same single semiconductor substrate. A part of one provided flash memory may be used as the memory 83, and another part thereof may be used as the data flash 1. By configuring the data flash 1 with an independent flash memory, access independence is maintained, and the need for arbitration is eliminated. Although not restricted, the CPU core 81, the memory 83, the data flash 1, and the I/O 82 are coupled to each other, for example via a bus. The bus may be hierarchized. The CPU core 81 may be a multiprocessor comprised of multiple CPU cores. The “CPU” merely represents a processor, and may be a MPU (Micro Processing Unit), a PE (Processor Element), a DSP (Digital Signal Processor), or any other processor.

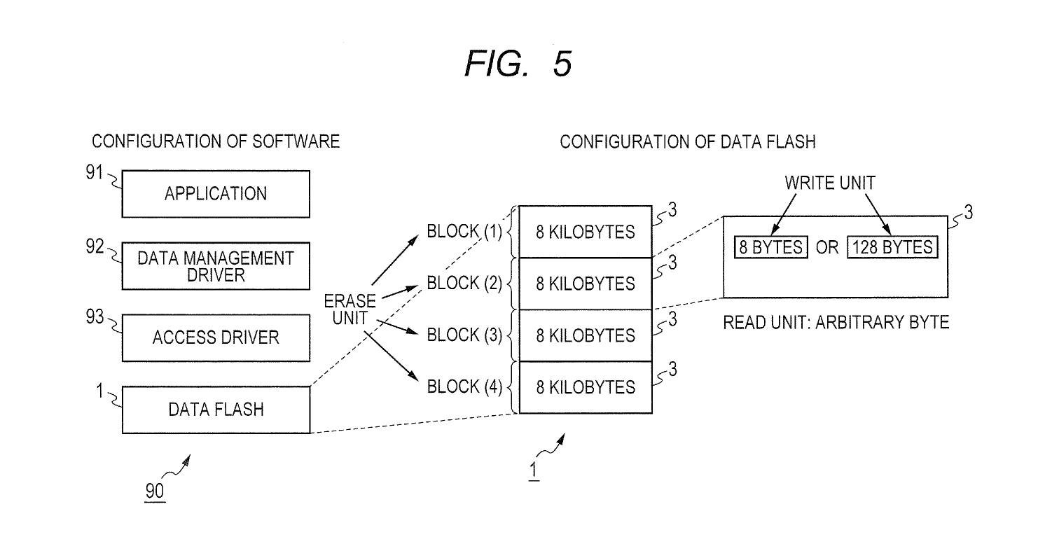

FIG. 5 is an explanation diagram showing a configuration example of the software (program) 90 and the data flash 1 in the system 70. Although not restricted, in the data flash 1, for example, a capacity thereof is 32 kilobytes, an erase unit is 8 kilobytes, a write unit is 8 bytes or 128 bytes, a read unit is an arbitrary byte, and there are included four 8-KB blocks 3 as erase units. The software 90 is comprised of an application 91, a data management driver 92, and an access driver 93. The application 91 causes the CPU core 81 to perform a control operation and communication processing based on a parameter acquired from the data management driver 92. The data management driver 92 executes data management on the data flash 1. The access driver 93 performs data writing, reading, and erasing on the data flash 1, in accordance with a request from the data management driver 92. By the application of this embodiment, the data management driver 92 supports variable-size data, and search efficiency is improved (search speed is enhanced) due to writing equalization.

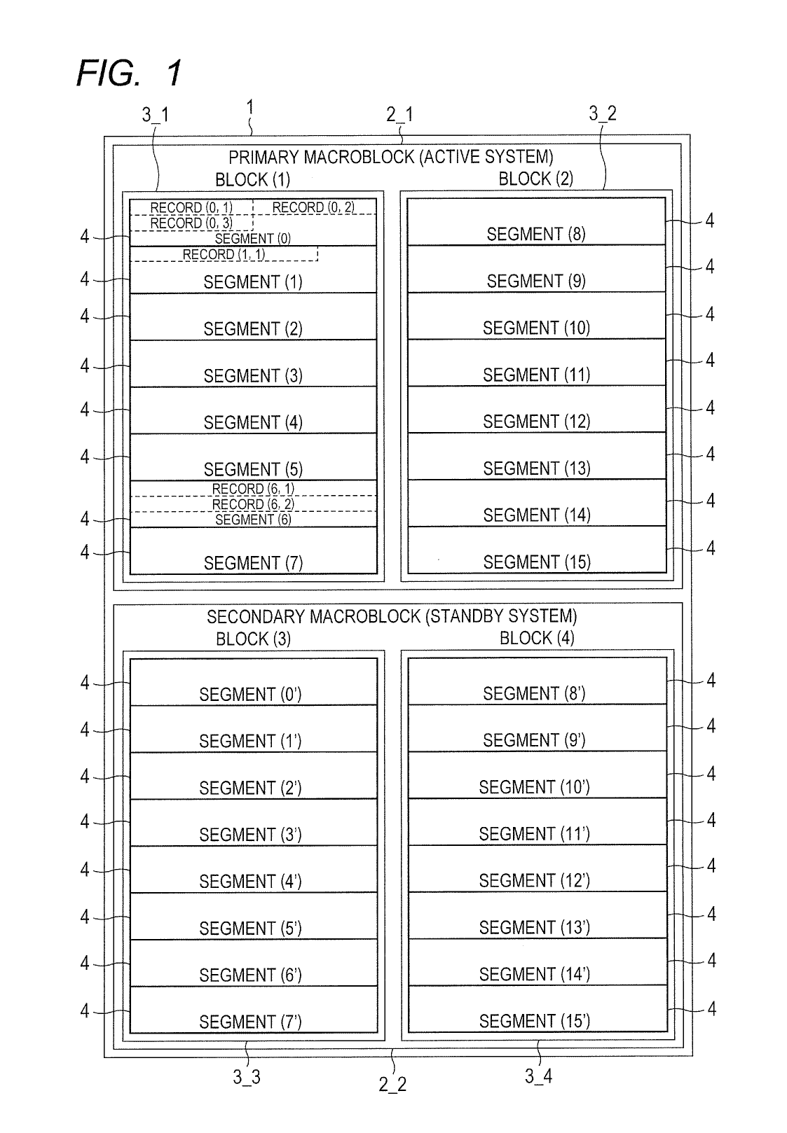

FIG. 1 is an explanation diagram showing a data configuration on the data flash 1.

The data configuration on the data flash 1 according to this embodiment will be described by way of example in which the capacity of the data flash 1 is 32 kilobytes.

The data flash 1 is configured with four 8-KB blocks (3_1 to 3_4) as erase units. The four blocks are divided into a primary macroblock 2_1 of two blocks and a secondary macroblock 2_2 of the other two blocks. Further, the primary macroblock 2_1 is divided into a plurality of segments 4. The number of divisions is equal to or greater than the number of types of (or the number of) parameters 5 stored in the data flash 1 and is preferably a power of 2. In this example, the number of divisions is any one of 1, 2, 4, 8, 16, 32 (=2⁰, 2⁴, 2², 2³, 2⁴, 2⁵). Further, the secondary macroblock 2_2 is also divided by the same number of divisions as the primary macroblock 2_1. In the example of FIG. 1, the primary macroblock 2_1 includes the first two blocks (blocks (1) and (2)) (3_1 and 3_2), the secondary macroblock 2_2 includes the remaining two blocks (blocks (3) and (4)) (3_3 and 3_4), and the number of divisions is 16. The primary macroblock 2_1 includes 16 segments 4 (segments (0) to (15)), and the secondary macroblock 2_2 includes 16 segments 4 (segments (0′) to (15′)).

A record 6 is written from the top of each segment. The record 6 contains the parameter 5 which a user wants to write to the data flash 1. The record 6 or the parameter 5 to be written is associated with the segment 4, e.g., by an identification number ID. For example, a record (0, x), a record (1, x), a record (2, x), . . . are configured from a parameter (0, t(x)), a parameter (1, t(x)), a parameter (2, t(x)), . . . , and associated with the segment (0), the segment (1), the segment (2), . . . , respectively. Here, a parameter (i, t(x)) is an update value of the ith parameter at time t(x). The ith parameter is a parameter of an identification number i (ID=i), and changes with time. The term “change with time” is not limited to change due to physical time dependence, but broadly refers to change from any cause. The parameter does not necessarily need to be written to the data flash 1 when it changes. The parameter (i, t(x)) represents the value, at time t(x), of the ith parameter written to the data flash 1 for the xth time. Whenever the parameter (i, t(1)), the parameter (i, t(2)), the parameter (i, t(3)), . . . are written to the data flash 1, the corresponding record (i, 1), record (i, 2), record (i, 3) are created and written in order from the start address of the corresponding segment (i). The last written value is the latest value, and addresses subsequent to the last written record in the segment indicate a blank area (unused area). FIG. 1 illustrates the write state of the record when the primary macroblock 2_1 is an active system and the secondary macroblock 2_2 is a standby system. The record (0, 1), the record (0, 2), and the record (0, 3) are written to the segment (0), the record (1, 1) is written to the segment (1), and the record (6, 1) and the record (6, 2) are written to the segment (6). The size of the record in each segment is a variable length.

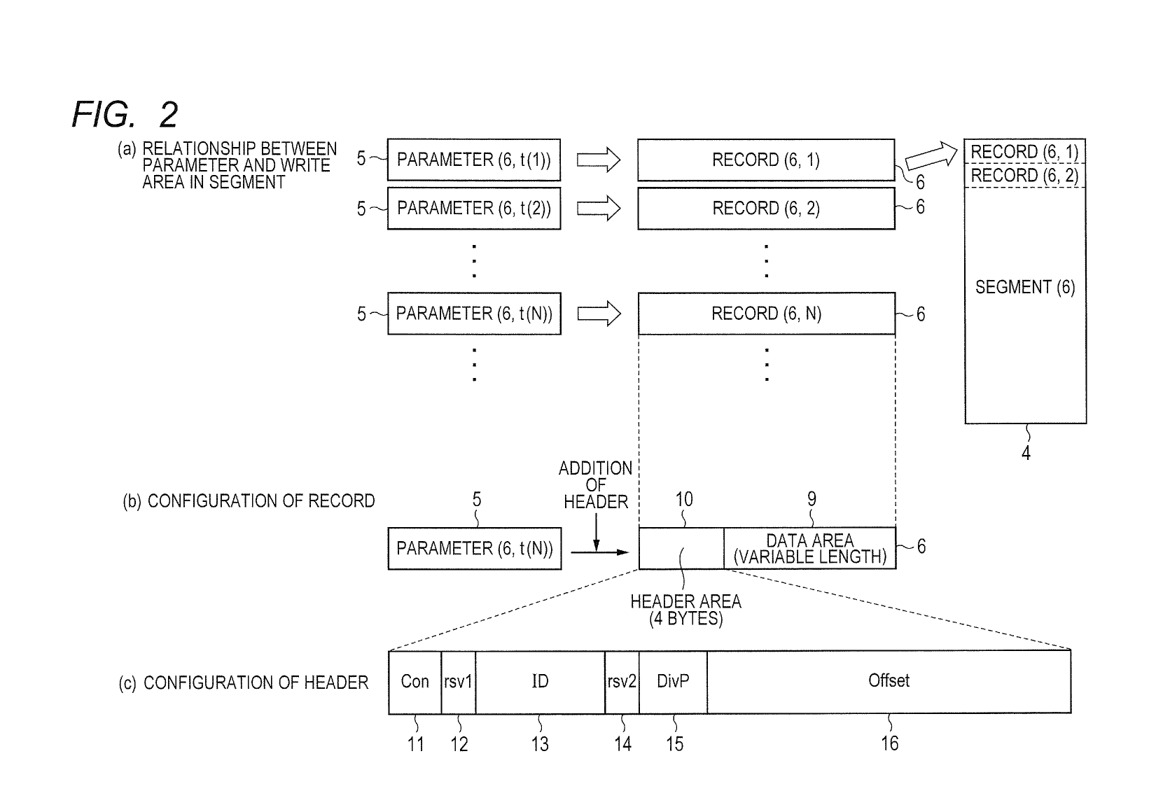

FIG. 2 is an explanation diagram showing the configuration of the record 6 on the data flash 1. Part (a) shows the relationship between the parameter and the write area in the segment. When the parameter (6, t(1)), the parameter (6, t(2)), . . . , the parameter (6, t(N)) which are update values of the sixth parameter are written to the segment (6), the record (6, 1), the record (6, 2), . . . , the record (6, N) corresponding to the respective update values are configured and written in order from the start address of the segment (6). Part (b) shows the configuration of the record. The record 6 is configured with a data area 9 and a header area 10. The data area 9 is the parameter (6, t(N)) itself and is of variable length. The header area 10 is composed of e.g. 4 bytes. Part (c) shows a configuration example of the header. The header is configured with a Con (Concatenation) field 11, a rsv1 (reserved) field 12, an ID (Identification) field 13, a rsv2 field 14, a DivP (Divided power) field 15, and an offset field 16.

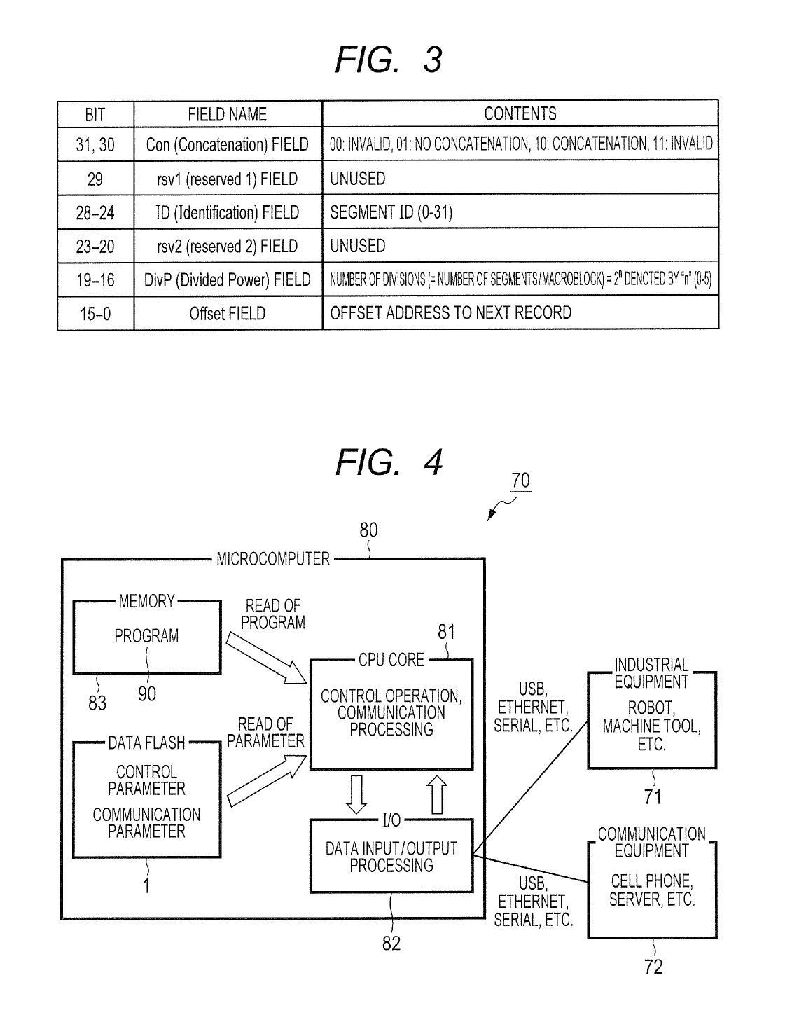

FIG. 3 is an explanation diagram showing in more detail the configuration of the header. The contents of the header are expressed in big-endian format.

Bits 31 and 30 are the Con field 11, which indicates whether the parameter falls within one record or continues to a subsequent record. In the field, b′01 indicates no concatenation, i.e., that the parameter falls within one record, b′10 indicates concatenation, i.e., that the parameter continues to a subsequent record, and b′00 and b′11 are invalid.

Bits 28 to 24 are the ID field 13, which indicates the ID of a storage segment, and takes a value from 0 to 31 because the maximum number of segments is 32.

Bits 19 to 16 are the DivP field 15, which indicates an exponent when the number of divisions is expressed as a power of 2, and takes a value from 0 to 5 because the number of divisions is 1, 2, 4, 8, 16, or 32.

Bits 15 to 0 are the offset field 16, which indicates an offset address to the next record. The offset address can range from a minimum write unit (minimum value) to a value (maximum value) obtained by subtracting the minimum write unit from a segment size. Since the minimum write unit is 8 bytes and the segment size is the maximum in the case where the number of divisions is 2, it takes a value from H′0008 to H′3FF8.

A bit 29 and bits 23 to 20 are reserved fields which are the rsv1 field 12 and the rsv2 field 14.

<Write Operation>

An operation for writing the parameter 5 to the data flash 1 by the data management driver 92 will be described in greater detail.

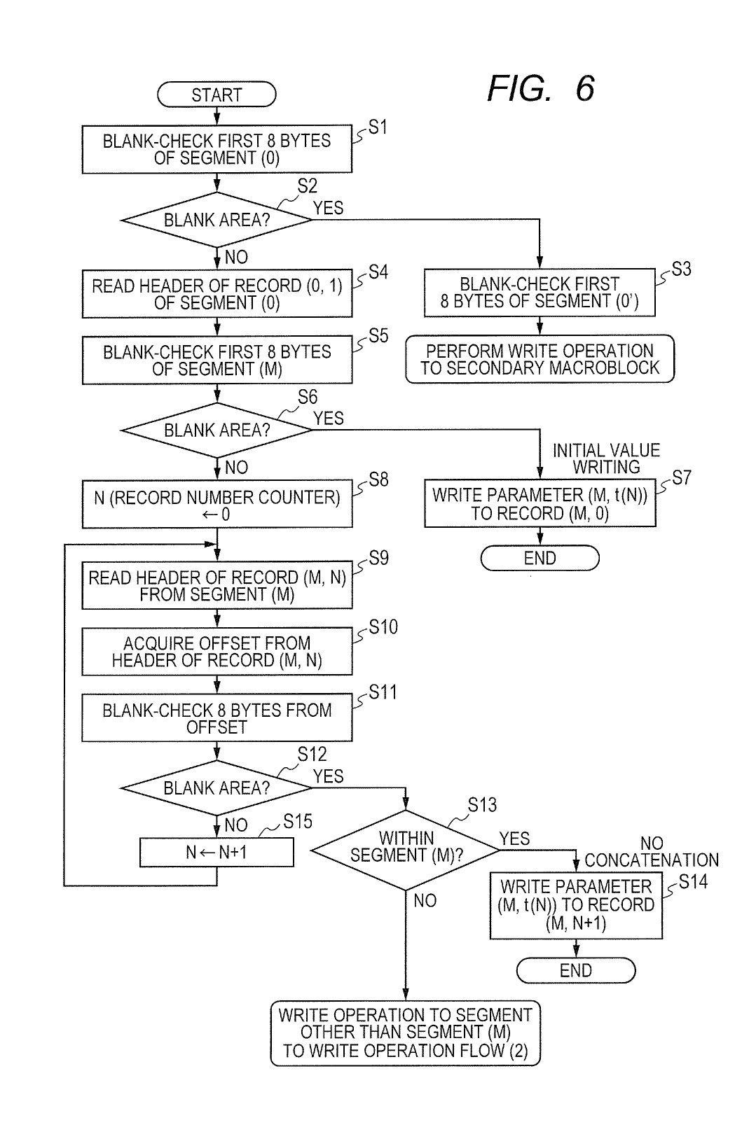

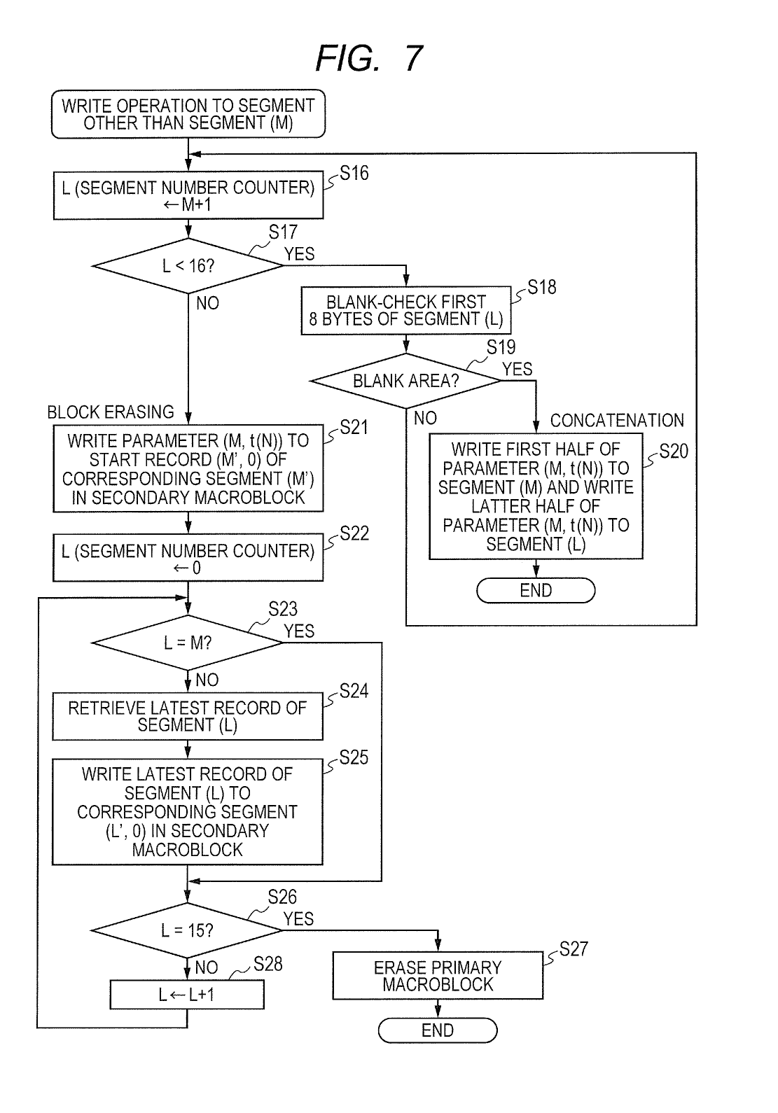

FIGS. 6 and 7 are flowcharts showing the operation for writing the parameter 5 to the data flash 1. FIG. 6 shows the first half and FIG. 7 shows the latter half.

Assume that the data flash 1 has a capacity of 32 kilobytes and is divided into the primary macroblock of 16 KB and the secondary macroblock of 16 KB, and 11 types of parameters are written to the data flash 1. Hereinafter, description will be made by way of example in which the primary and secondary macroblocks are each divided into 16 segments (the number of divisions is 16) and the Mth parameter (parameter (M, t(N))) is written. The data structures of the record and the header are the same as illustrated in FIGS. 2 and 3.

The first 8 bytes of the segment (0) as the top of the primary macroblock are read and blank-checked (S1). In the blank check, it is determined whether the read area is a blank area, that is, an area where data has not yet been written after erasure. In general, the data flash has a blank-check function, and the access driver 93 uses the blank-check function to determine the blank area; however, some flash memories might utilize the following specification of the flash memory. According to the specification of the flash memory, the erased state is all 0s or all 1s. In the case where the erased state is all 0s, if a value other than 0 is written, it is determined that the area is not the blank area. In the case where the erased state is all 1s, if a value other than 1 is written, it is determined that the area is not the blank area. For example, assume that the record is already written to the segment (0). Four bytes of the first 8 bytes are header information in which bits 31 and 30 are the Con field 11. Since b′00 and b′11 are invalid in the Con field 11, if the record is written, a value other than b′00 and b′11 is indicated. Therefore, it can be determined that the area is the blank area in the case of b′00 or b′11. Similarly, all bits of the read 8 bytes may be checked. Further, the first 8 bytes are merely an example, and any number of bytes may be checked. For example, the four bytes as the header area may be read and blank-checked, or only the first 1 byte including the Con field 11 may be read and blank-checked.

The result of the blank check in S1 is determined (S2). As a result of S2, if the first 8 bytes of the segment (0) are the blank area, at this time the primary macroblock is the standby system and the secondary macroblock of the active system is the macroblock to which the parameter is written; accordingly, a write operation to the secondary macroblock is performed (S3). The write operation to the secondary macroblock is the same as the primary macroblock of the active system, which is shown after S4, and therefore will not be described.

As the result of S2, if the first 8 bytes of the segment (0) are not the blank area, at this time the primary macroblock is the active system. The header of the record (0, 1) which is the start record of the segment (0) in the primary macroblock is read (S4). The number of divisions in the macroblock is obtained from the DivP field 15 of the header of the record (0, 1) read in S4, the start address of the segment (M) is calculated based on the number of divisions, and the first 8 bytes of the segment (M) are blank-checked (S5). Based on the result, it is determined whether the segment (M) is a blank area (S6). If the segment (M) is the blank area, the parameter (M, t(N)) is written to the record (M, 0), and the process ends (S7). This is the writing of an initial value.

As a result of S6, if the segment (M) is not the blank area, a counter N is initialized to zero (S8). At this time, the counter N is used to determine a blank record number. Then, the header of the record (M, N) is read from the segment (M) (S9). An offset address is acquired from the header of the record (M, N) read in S9 (S10). Eight bytes from the offset address acquired in S10 are blank-checked (S11), and it is determined whether an area following the record (M, N) in the segment (M) is a blank area (S12). If it is determined in S12 that the area is the blank area, it is determined whether the parameter (M, t(N)) can be written within the segment (M) (S13). If it is determined in S13 that the parameter (M, t(N)) can be written within the segment (M), the parameter (M, t(N)) is written to the record (M, N+1) (S14), and the write operation ends. This is the writing without concatenation. If it is determined in S12 that the area is not the blank area, the counter N for determining a blank record number in the segment (M) is incremented by 1 (S15), and the flow returns to S9.

As described above, by reading the DivP field 15 contained in the header of the record written to the top of the macroblock, the number of divisions in the macroblock is obtained. Since the parameter and the segment are one-to-one associated with each other, the segment to which the parameter is to be written is uniquely determined from the ID of the parameter. To search for the blank area (unused area) where the parameter can be written, it is only necessary to check on the offset contained in the header in order from the top in the segment, thus making it possible to minimize a search step. Thereby, it is possible to find the blank area in a short search time (search step) and write the parameter to the blank area.

If it is determined in S13 that the parameter (M, t(N)) can not be written within the segment (M), a write operation to other segments than the segment (M) is performed. The subsequent flow is shown in FIG. 7.

A counter L is initialized to M+1 (S16). At this time, the counter L is used to determine a blank segment number. It is determined whether there is an unused segment in the primary macroblock, that is, the segment number (L) is smaller than the number of divisions (=16) (S17).

If it is determined in S17 that there is an unused segment in the primary macroblock, the first 8 bytes of the segment (L) are blank-checked (S18). It is determined whether the segment (L) is a blank area (S19). If the segment (L) is not the blank area, the flow returns to S16. If the segment (L) is the blank area, the first half of the parameter (M, t(N)) is written to the segment (M) and the latter half of the parameter (M, t(N)) is written to the segment (L) (S20), and the write operation ends. This is the writing with concatenation.

Thereby, if there is no space in the corresponding segment, it is possible to search for an unused segment (blank segment) and use it as a new writable segment. Further, the selected segment to which the next Mth parameter is to be written can be easily calculated from the offset field in the header information of data last written in the Mth segment.

If it is determined in S17 that there is no unused segment (blank segment) in the primary macroblock of the active system, the parameter (M, t(N)) is written to the start record (M′, 0) of the corresponding segment (M′) in the secondary macroblock of the standby system (S21). An operation after S21 is a write operation with block erasing, and configures a part of an operation for switching between the macroblock of the active system and the macroblock of the standby system.

The counter L for the segment number is initialized to zero (S22). In the operation for switching between the macroblock of the active system and the macroblock of the standby system, only the latest record of each parameter is transcribed from the active system to the standby system. At this time, the counter L is used as a pointer for indicating the segment number of a segment having the latest record to be retrieved and transcribed.

It is determined whether the segment indicated by the counter L is the segment (M), that is, the counter L is equal to the segment number M (S23). As a result of the determination, if the segment indicated by the counter L is equal to the segment (M), the flow proceeds to S26. In S23 if the segment indicated by the counter L is different from the segment (M), the latest record of the segment (L) is retrieved (S24). The retrieval is performed by calculating the start address of the next record area based on the offset address of the header and blank-checking the area. The latest record of the segment (L) is written to the start record (L′, 0) of the corresponding segment (L′) in the secondary macroblock (S25). It is determined whether there is a remaining segment having the latest record that needs to be retrieved and transcribed, that is, the segment number L is equal to 15 which is the last segment number of the macroblock (S26). If it is determined in S26 that there is a remaining segment, the counter L for the segment number which indicates the segment having the latest record to be retrieved is incremented by 1 (S28), and the flow returns to S23. If it is determined in S26 that there is no remaining segment, the whole of the primary macroblock is erased (S27), and the write operation ends. After this, the primary macroblock becomes the standby system, and the secondary macroblock becomes the active system.

Thereby, it is possible to alternately switch between the active system and the standby system of the primary and secondary macroblocks.

<Example of Write Operation>

An example of the write operation to the data flash 1 will be described in greater detail, based on a capacity of 32 kilobytes and 11 types of parameters as described above.

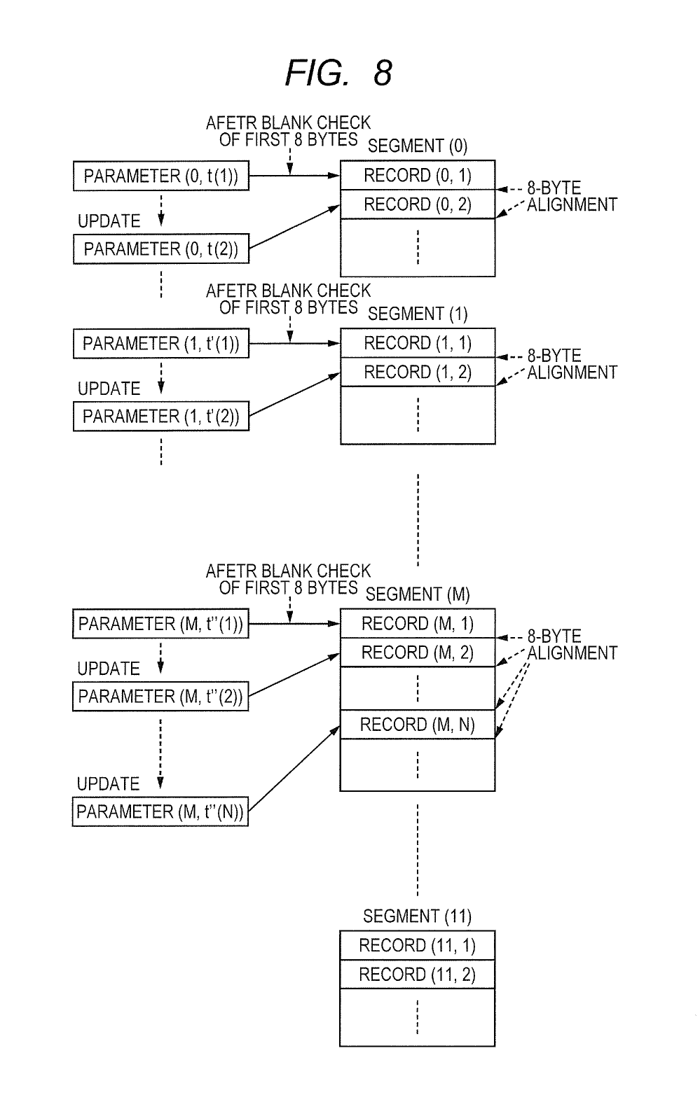

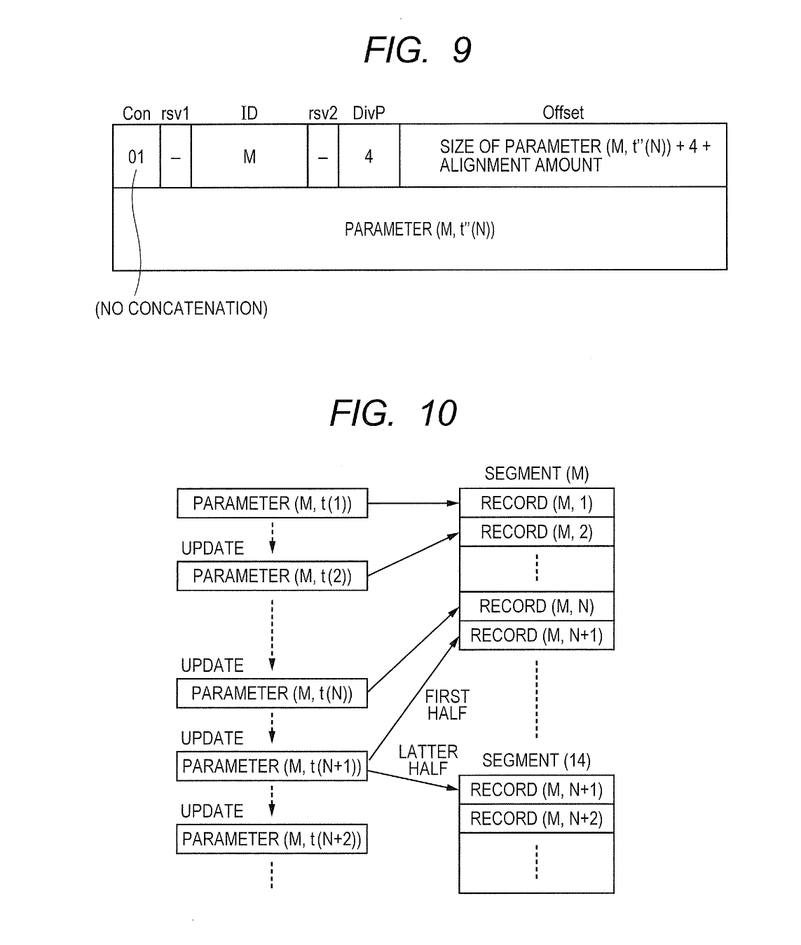

FIG. 8 is an explanation diagram showing the operation for writing the parameter to the data flash (without concatenation). FIG. 9 is an explanation diagram showing the contents of the record (M, N) in FIG. 8.

Due to 11 types of parameters, the primary macroblock and the secondary macroblock are each divided into 16 segments so as to be able to store different types of parameters in different segments. When the user provides the number of types of parameters through the application at the first activation, the number of block divisions is set to the minimum value not less than the number of types of parameters. In the case where the number of types of parameters is larger than a predetermined number, for example, 32 illustrated in FIGS. 1 to 3, the user consolidates parameters so that the number of types of parameters becomes equal to or less than 32.

Set values in the header will be described by way of example of the Mth parameter.

In the case where the Mth parameter (parameter (M, t″(N))) is updated at time t″(N) and the record (M, N) is written to the segment (M), set values in the header are as follows. That is, the Con field specifies b′01 indicating no concatenation, the ID field specifies M of the segment ID, the DivP field specifies 4 indicating 16-segment division, and the offset field specifies “the size of the parameter (M, t″(N))+4 (header size)+an alignment amount”. The alignment amount is an amount for aligning the boundary between adjacent old and new records with a boundary for e.g. every 8 bytes of addresses (8-byte alignment). The size of alignment is determined based on the write unit of the flash memory configuring the data flash 1. In the case where the write unit is 8 bytes, a multiple of 8 bytes can be used as the alignment size. Typically, the same number of bytes as the write unit is used as the alignment size.

The record (0, 1) is created by adding the header to the parameter (0, t(1)) as the value of the first parameter at time t(1), and written to the start address of the segment (0). An area where data has not yet been written after erasure is a blank area. At this time, in the segment (0), the area of addresses subsequent to the area where the record (0, 1) is written is the blank area. The access driver 93 blank-checks the first 8 bytes of the segment (0), thereby confirming whether the segment (0) is the blank area. Further, when the first parameter is updated at time t(2) and the parameter (0, t(2)) is written, the record (0, 2) is created from the parameter (0, t(2)) and written from an address subsequent to the area where the record (0, 1) is stored in the segment (0). This write address is calculated using the value of the offset field in the header of the record (0, 1), the first 8 bytes of the write address are blank-checked by the access driver 93 for confirmation of the blank area, and then writing is performed.

In the same way, every time the second parameter is updated, the record is written to the segment (1). The record (1, 1), the record (1, 2), . . . configured by adding respective headers to the parameter (1, t′(1)), the parameter (1, t′(2)), . . . are written in order from the start address of the segment (1). Further, in the same way, the third to eleventh parameters are written from the respective start addresses of the segments (2) to (11). The data management driver 92 can easily calculate the start addresses of the segments (1) to (11) based on the number M of divisions acquired at the time of writing the first parameter. Further, the access driver 93 blank-checks the first 8 bytes of each segment (0) to (11) to confirm whether each segment (0) to (11) is a blank area.

During the above operation, the size of a blank area within the segment might become insufficient. An operation in such a case will be described below.

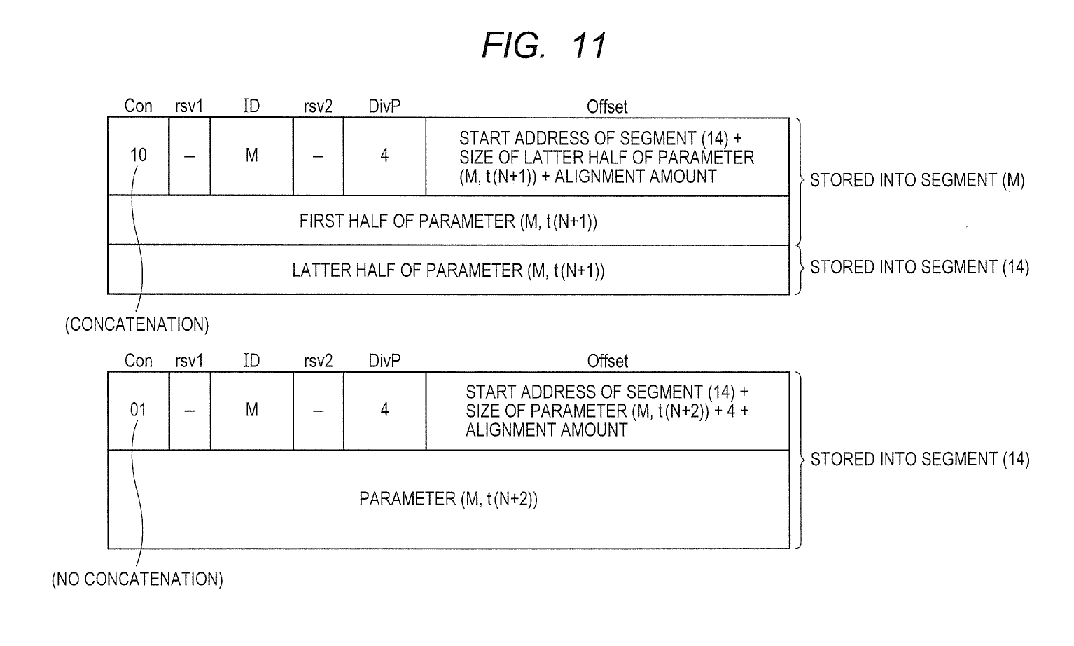

FIG. 10 is an explanation diagram showing the operation for writing the parameter 5 to the data flash 1 with concatenation. FIG. 11 is an explanation diagram showing the contents of the record (M, N+1) and the record (M, N+2) in FIG. 10.

For example, assume that the (M+1)th parameter (parameter (M, t(N+1))) is updated at time t(N+1) and is going to be written as the record (M, N+1) to the segment (M), but the remaining blank area in the segment (M) is smaller than the size of the record (M, N+1)+8 bytes. The size of “+8 bytes” is necessary to write the header of the record. The header area occupies 4 bytes, but requires at least 8 bytes due to 8-byte alignment according to the write unit. In such a case, the record (M, N+1) is divided into halves. The first half is written to the remaining blank area in the segment (M). As for the latter half, a segment that is blank in the whole area (hereinafter referred to as a blank segment) is found first from the primary macroblock of the active system, and the latter half is written to the first blank segment.

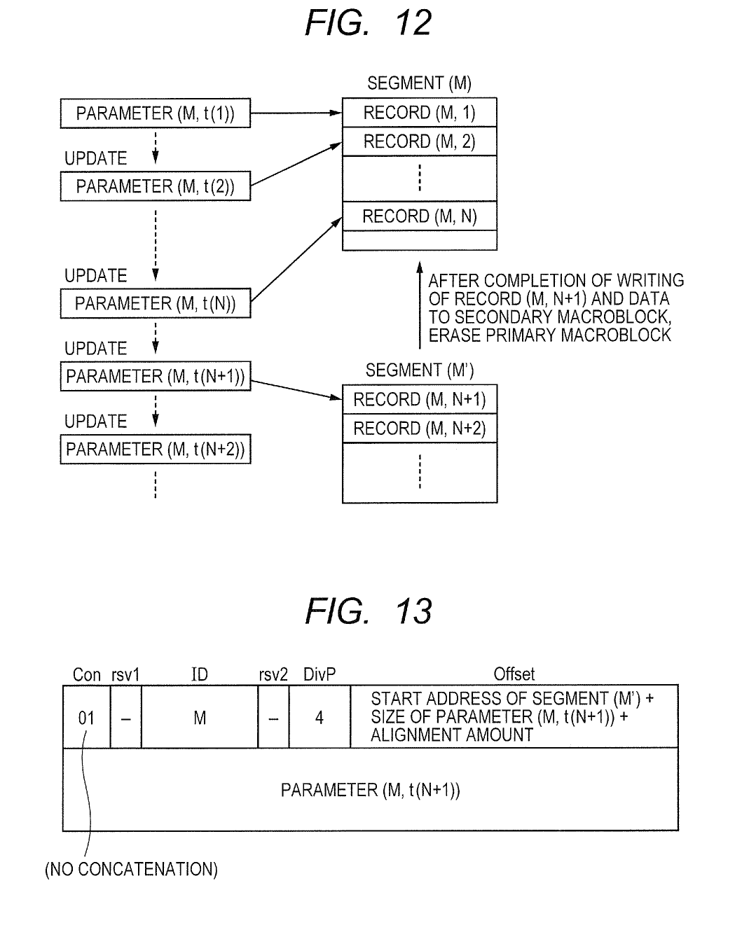

In the example of FIG. 10, segments up to (13) are not blank segments, and the segment (14) is a blank segment. Further, the case of no blank segment remaining in the macroblock will be described later with reference to FIGS. 12 and 13.

As shown in the upper half of FIG. 11, in the header of the record (M, N+1), the Con field specifies b′10 indicating concatenation, the ID field specifies M of the segment ID, the DivP field specifies 4 indicating 16-segment division, and the offset field specifies “the start address of the segment (14)+the size of the latter half of the parameter (M, t(N+1))+an alignment amount”. The data area is divided into the first half and the latter half. The header and the first half of the data is written to the segment (M), and the latter half of the data is written from the start address of the segment (14). In the offset field, the size of the latter half of the parameter (M, t(N+1)) is added to the start address of the segment (14), which makes it possible to calculate the start address of the next record when it is written.

After the record (M, N+1) is written, in the case where the Mth parameter (parameter (M, t(N+2))) is updated at time t(N+2), the contents of the header of the record (M, N+2) are shown in the lower half of FIG. 11. That is, the Con field specifies b′01 indicating no concatenation, the ID field specifies M of the segment ID, the DivP field specifies 4 indicating 16-segment division, and the offset field specifies “the start address of the segment (14)+the size of the parameter (M, t(N+2))+4 (header size)+an 8-byte alignment amount”. In the same way, the Mth parameter is updated in the segment (14).

During the above operation, there might remain no blank segment in the macroblock of the active system. An operation in such a case will be described below.

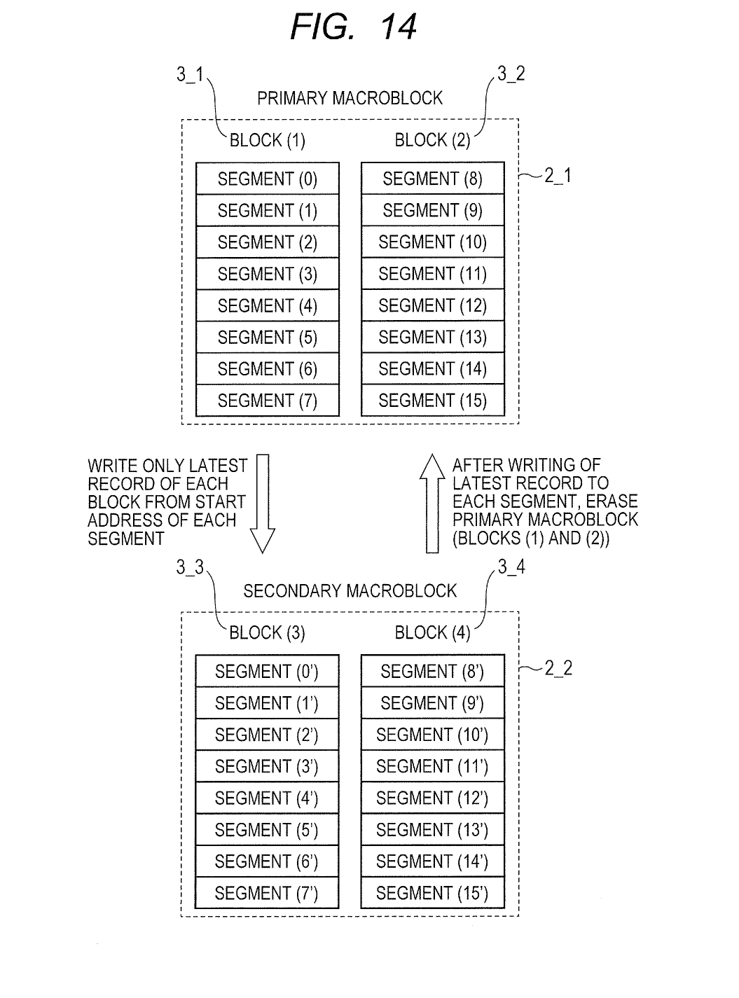

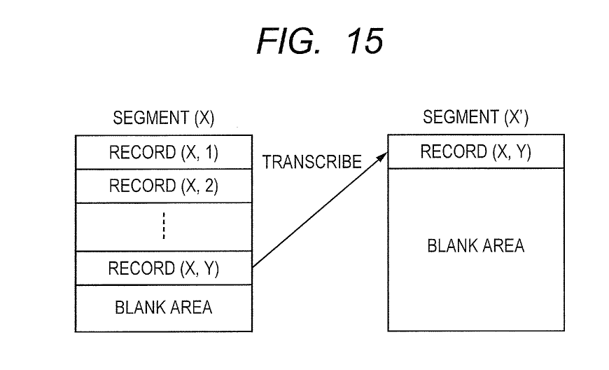

FIG. 12 is an explanation diagram showing an operation in the case where block erasing occurs by writing the parameter to the data flash 1. FIG. 13 is an explanation diagram showing the contents of the record (M, N+1) in FIG. 12. FIG. 14 is an explanation diagram showing an operation for switching between the active system and the standby system of the primary and secondary macroblocks. FIG. 15 is an explanation diagram showing a transfer operation of the latest record in the switching operation.

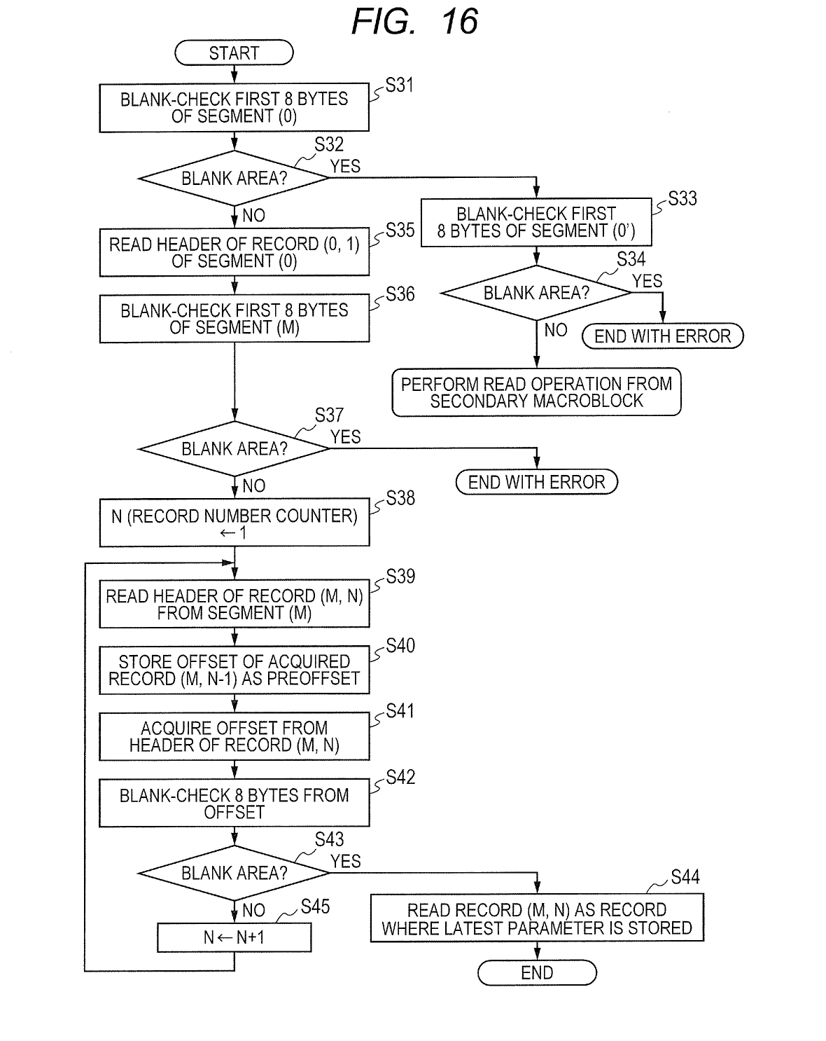

For example, assume that the Mth parameter (parameter (M, t(N+1))) is updated at time t(N+1) and is going to be written as the record (M, N+1) to the segment (M) as shown in FIG. 12. In this case, if the remaining blank area in the segment (M) is smaller than the size of the record (M, N+1)+8 bytes (record header write size), the primary macroblock of the active system is searched for a blank segment. As a result, if there remains no blank segment in the macroblock, an operation for switching between the active system and the standby system is performed. The operation will be described below. The record (M, N+1) is written from the start address of the segment (M′) in the secondary macroblock which is the standby system at this time. In the header of the record (M, N+1), as shown in FIG. 13, the Con field specifies b′01 indicating no concatenation, the ID field specifies M of the segment ID, the DivP field specifies 4 indicating 16-segment division, and the offset field specifies “the start address of the segment (M′)+the size of the parameter (M, t(N+1))+an 8-byte alignment amount”. After the completion of the writing of the record (M, N+1), only the latest record (X, Y) of each segment (X) (X is 0 to 15 except M) other than the segment (M) in the primary macroblock is transcribed to an area beginning with the start address of the segment (X′) in the secondary macroblock, as shown in FIGS. 14 and 15. Then, the blocks (1) and (2) configuring the primary macroblock are erased. The primary macroblock in which the blocks (1) and (2) are erased becomes the standby system, and the active system is switched to the secondary macroblock. The retrieval of the latest record can be performed by a method in which the header area of the record is read in order from the top of each segment and the record containing the header that is last read when the blank area is reached is determined to be the latest. For more details, it can be achieved in the same way as in a read operation described later with reference to FIG. 16.

<Read Operation>

FIG. 16 is a flowchart showing an operation for reading the parameter 5 from the data flash 1.

An example of the read operation from the data flash 1 in which the Mth parameter (parameter (M, t(N))) is read from the record (M, N) will be described, based on a capacity of 32 kilobytes and 11 types of parameters as in the above write operation.

First, the first 8 bytes of the segment (0) which is the top of the primary macroblock of the active system are read and blank-checked (S31), and the result is determined (S32). As a result of S32, if the first 8 bytes of the segment (0) are a blank area, at this time the primary macroblock is the standby system and the secondary macroblock of the active system is the macroblock from which the parameter is read; accordingly, a read operation from the secondary macroblock is performed (S33 to S34). The read operation from the secondary macroblock is the same as the primary macroblock of the active system, which is shown after S35, and therefore will not be described.

As the result of S32, if the first 8 bytes of the segment (0) are not the blank area, the primary macroblock is the active system. The header of the record (0, 1) which is the start record of the segment (0) in the primary macroblock is read (S35). The number of divisions in the macroblock is obtained from the DivP field 15 of the header of the record (0, 1) read in S35, the start address of the segment (M) is calculated based on the number of divisions, and the first 8 bytes of the segment (M) are blank-checked (S36). Based on the result, it is determined whether the segment (M) is a blank area (S37). If the segment (M) is the blank area, there is no data written in the segment (M), and consequently the process ends with an error.

As a result of S37, if the segment (M) is not the blank area, the counter N is initialized to 1 (S38). At this time, the counter N is used to determine a record number storing the latest parameter. Then, the header of the record (M, N) is read from the segment (M) (S39). The offset of the acquired record (M, N−1) is stored as PreOffset (S40). If there is no acquired record (N=1), the start address of the segment (M) is stored as PreOffset. The offset is acquired from the header of the record (M, N) read in S39 (S41). Eight bytes from the offset acquired in S41 are blank-checked (S42), and it is determined whether an area following the record (M, N) in the segment (M) is a blank area (S43). If it is determined in S43 that the area is the blank area, there exists no record written subsequently to the record (M, N) in the segment (M); therefore, it is determined that the parameter (parameter (M, t(N))) stored in the record (M, N) is the latest parameter. Then, the record (M, N) is read based on the PreOffset stored in S40, and the Mth and latest parameter (parameter (M, t(N))) is acquired (S44). Then, the read operation ends.

If it is determined in S43 that the area is not the blank area, it is determined that there is still a new record in the segment (M); accordingly, the counter N is incremented by 1 (S45), and the flow returns to S39.

As described above, by reading the DivP field 15 contained in the header of the record written to the top of the macroblock, the number of divisions in the macroblock is obtained. Since the parameter and the segment are one-to-one associated with each other, the segment to be accessed is uniquely determined from the ID of the parameter to be read. To search for the latest value of each parameter, it is only necessary to check on the offset contained in the header in order from the top in the segment, thus making it possible to minimize a search step. Thereby, it is possible to find and read the latest value of the parameter in a short search time (search step).

### Second Embodiment

### Conversion Table for Associating Segment ID with Array Name

In general, the user manages the parameter stored in the data flash 1 by an array used in a high-level language such as the C language. Accordingly, the application 91 parameter-accesses the data management driver 92 and the access driver 93 by an array name. In the example shown in the first embodiment, the parameter is managed by the ID; therefore, a conversion table for the array name and the ID is provided to associate the array name with the parameter.

In this embodiment, one of the segments included in the data flash 1 is allotted as a conversion table area for the array name and the parameter ID.

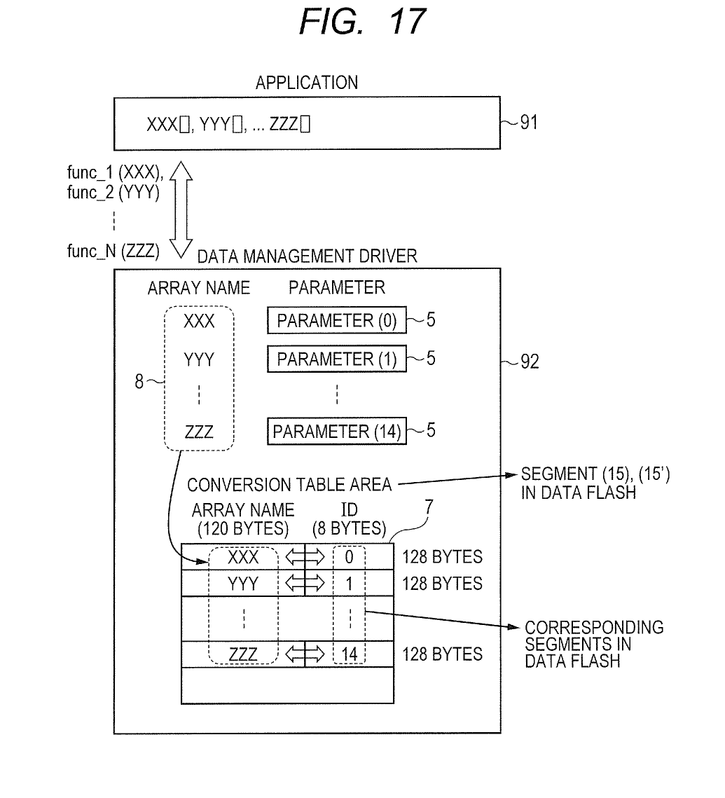

FIG. 17 is an explanation diagram showing a configuration example of a conversion table 7 on the data flash 1 according to the second embodiment.

In the data configuration illustrated in the first embodiment, the segment (15) is used as a conversion table storage area for storing the conversion table 7 for converting the array name into the ID, in place of a record storage area. The segment (15) of the primary macroblock and the segment (15′) of the secondary macroblock are used as the conversion table storage area. The application 91 is described using an array (XXX, YYY, . . . ZZZ), and accesses the data management driver 92, using array names (XXX, YYY, . . . ZZZ). In the conversion table 7, the array names (XXX, YYY, . . . ZZZ) are associated with the parameter IDs. As described in the first embodiment, the parameter IDs are associated with the segments in the data flash 1; therefore, the array names are associated with the segments through the conversion table 7. Although not restricted, in write units of 128 bytes, the 120-byte array name and the 8-byte ID are associated with each other and stored in the conversion table 7.

When the application 91 requests the writing of a parameter by an array name, the data management driver 92 refers to the conversion table 7. If the array name inputted from the application 91 has been registered, the corresponding parameter ID is obtained, and the parameter is written to the corresponding segment. If the array name inputted from the application 91 has not been registered in the conversion table 7, the array name and a new ID are registered in the conversion table 7. In the case of no unused area in the segment and switching between the macroblocks, the conversion table 7 is written to the segment (15′) of the secondary macroblock of the standby system, and then the primary macroblock of the active system including the segment (15) is erased, as in the case of the latest record.

When the application 91 requests the reading of a parameter by an array name, the data management driver 92 refers to the conversion table 7. If the array name inputted from the application 91 has been registered, the corresponding parameter ID is obtained, and the parameter is read from the corresponding segment.

This enables the user's access by the array name through the application 91, though the number of segments for storing records is reduced by one.

A write operation and a read operation will be described in greater detail.

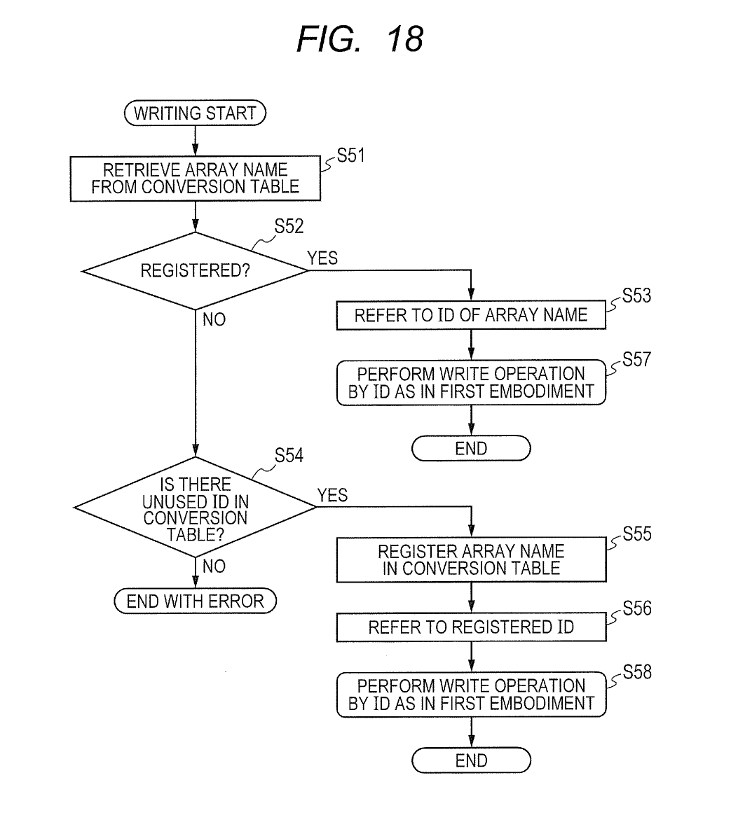

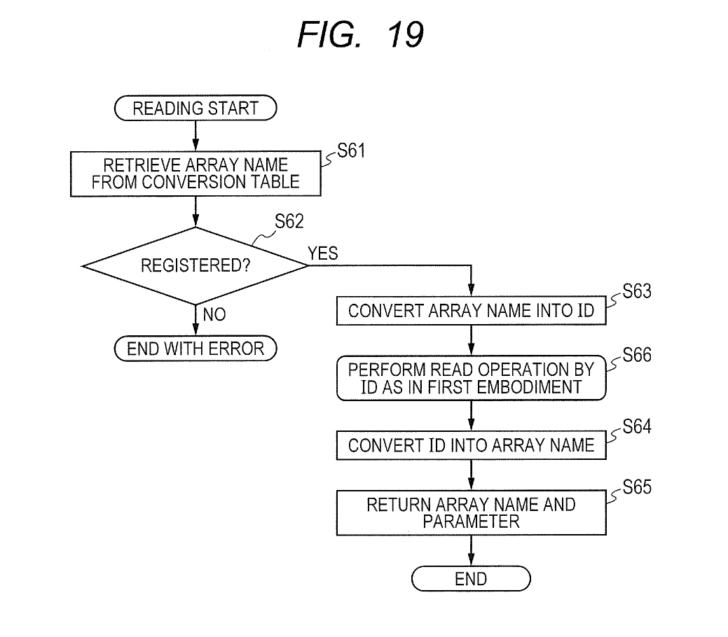

FIG. 18 is a flowchart showing the write operation to the data flash 1.

The data management driver retrieves an array name inputted from the application 91 in the conversion table (S51). The retrieval result of S51 is determined (S52).

If the array name has been registered, an ID corresponding to the array name is acquired by referring to the conversion table 7 (S53). The same write operation as in the first embodiment is performed using the acquired ID (S57), and the process ends.

If the array name has not been registered, it is determined whether there is an unused ID in the conversion table 7 (S54). It is determined that there is no unused ID if the number of registered IDs is greater than the number of divisions in the macroblock, and it is determined that there is an unused ID if the number of registered IDs is not greater than the number of divisions in the macroblock. If there is no unused ID, the process ends with an error.

If there is an unused ID, the array name is associated with the smallest unused ID and registered in the conversion table 7 (S55). The ID registered in S55 is referred to (S56), and the same write operation as in the first embodiment is performed (S58). Then, the process ends.

FIG. 19 is a flowchart showing the read operation from the data flash 1.

The data management driver retrieves an array name inputted from the application 91 in the conversion table 7 (S61). The retrieval result of S61 is determined (S62). If the array name has not been registered, the process ends with an error.

In S62 if the array name has been registered, an ID corresponding to the array name is acquired by referring to the conversion table 7 (S63). The same read operation as in the first embodiment is performed using the acquired ID (S66). After the completion of reading, the ID is converted into the array name by again referring to the conversion table 7 (S64). The converted array name in S64 and the read parameter are returned to the application 91 (S65), and the process ends.

Thus, the user can access the data flash 1 by the array name through the application 91. Therefore, the user can use the array name used in the application 91, which makes it easier to manage the parameter. Further, in the case of use in a plurality of applications, ID management in the applications is facilitated.

Third Embodiment

### Update of Correspondence Relationship Between Segment ID and Array Name in Conversion Table

The third embodiment for enabling the update of the array in the second embodiment will be described. The conversion table area in the second embodiment is expanded to an area larger than the number of segments.

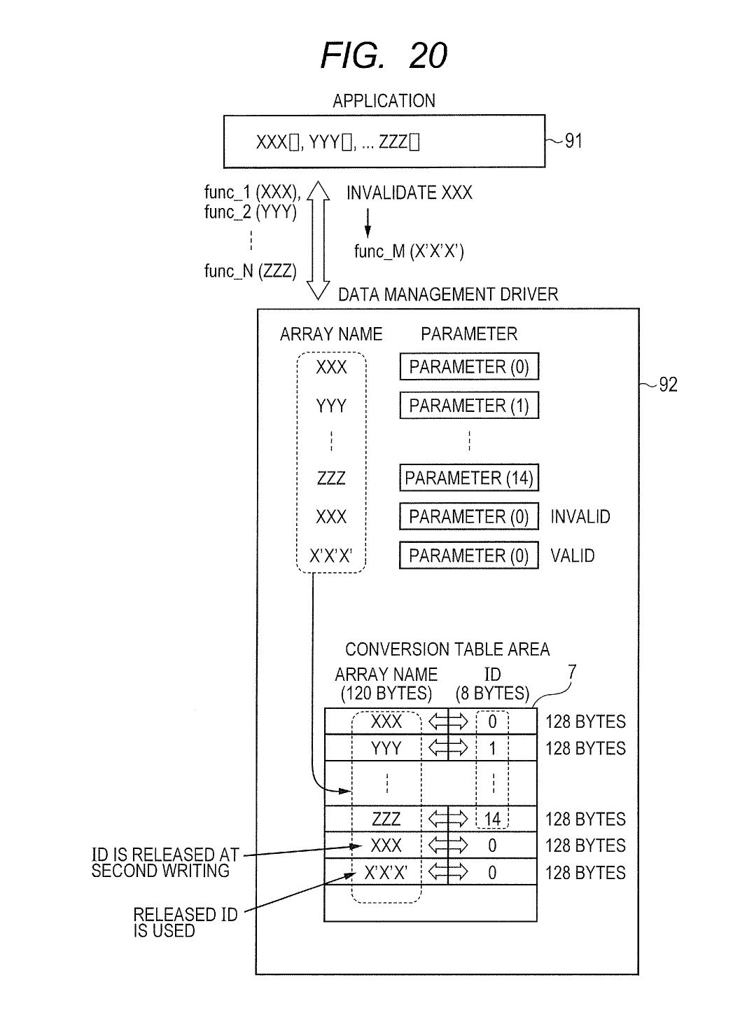

FIG. 20 is an explanation diagram showing the configuration of the conversion table 7 on the data flash 1 according to the third embodiment.

The application 91 requests the data management driver 92 to invalidate a registered array name. For example, by calling a function with an argument of an array name to be invalidated, the application 91 can request the data management driver 92 to invalidate the array name. Upon receiving the request to invalidate the registered array name from the application 91, the data management driver 92 writes the registered array name to be invalidated and the corresponding ID to the last area of the conversion table area 7.

In access to the data flash 1 in which the array name is specified, the data management driver 92 refers to the conversion table 7 and checks whether the array name inputted from the application 91 has been registered in the conversion table 7. The data management driver 92 searches for the array name inputted by the user by accessing, in order from the top, the segment (15) (or the segment (15′) when the secondary macroblock is the active system) where the conversion table 7 is stored. In the case where, in write units of 128 bytes, the 120-byte array name and the 8-byte ID are associated with each other and stored in the conversion table 7, the data management driver 92 reads each array name in units of 128 bytes to determine the array name inputted by the user. When the data management driver 92 finds the array name inputted from the application 91, the data management driver 92 does not stop the search, but continues the search with the blank check for every 128 bytes until the end of the conversion table area. In the case where the same array name exists an even number of times, the array name and the associated ID are invalidated, so that another array name can be associated with the ID and used.

In the example of FIG. 20, first the array names XXX, YYY, . . . ZZZ are associated with the parameter (0), the parameter (1), . . . the parameter (14), and the array name XXX and the ID “0”, the array name YYY and the ID “1”, . . . the array name ZZZ and the ID “14” are stored in units of 128 bytes in order from the start address of the conversion table 7. Upon receiving a request to invalidate the array name XXX from the application 91, the data management driver 92 adds the array name XXX and the ID “0” to the tailing 128-byte area of the conversion table 7. Thus, the array name XXX exists two times in the conversion table 7, and is therefore invalidated, so that the ID “0” can be associated with another array name and used. Then, when a function func_M(X′X′X′) with an argument of an array name X′X′X′ is called by the application 91, the data management driver 92 adds the array name X′X′X′ and the ID “0” to the tailing 128-byte area of the conversion table 7. Thus, the array name X′X′X′ can be associated with the ID “0” which is available due to the above invalidation.

Further, it is possible to revalidate an invalidated array name. By calling a function, the application 91 requests the data management driver 92 to revalidate an invalidated array name. Upon receiving the request to revalidate the invalidated array name from the application 91, the data management driver 92 retrieves an unused or invalidated ID and writes the array name and the retrieved ID to the last area of the conversion table area. In the case where the same array name exists three times in the conversion table 7, the data management driver 92 determines that the array name and the associated ID are valid again. In the same way, the data management driver 92 determines that the array name and the ID that exist an odd number of times in the conversion table 7 are valid, and determines that the array name and the ID that exist an even number of times are invalid.

Thus, it is possible to update the ID of data managed by the data flash 1 and the associated array name and consequently change parameter contents in the same segment.

While the invention made above by the present inventors has been described specifically based on the illustrated embodiments, the present invention is not limited thereto. It is needless to say that various changes and modifications can be made thereto without departing from the spirit and scope of the invention.

For example, the primary macroblock and the secondary macroblock may be implemented as a part area of a large-scale flash memory, or may be implemented using separate nonvolatile memory chips.

What is claimed is:

1. A data storage flash memory management method for storing k varying parameters (k is a positive integer) in a flash memory including j blocks (j is an even number not less than 2) as erase units, the method comprising the steps of:
dividing the j blocks into two areas which are a primary macroblock and a secondary macroblock, each comprising j/2 blocks;
dividing each of the primary macroblock and the secondary macroblock into k or more segments each having an equal memory capacity, with one of the macroblocks as an active system and the other as a standby system;
one-to-one associating the k parameters with k segments of the k or more segments; and
writing or reading each parameter to/from a corresponding segment in an active-system macroblock.

2. The data storage flash memory management method according to claim 1, comprising the steps of:
writing an Mth parameter (M is a positive integer not more than k) included in the k parameters from a start address of an Mth segment in the active-system macroblock, with header information added to the Mth parameter; and
writing the Mth parameter from a start address of a blank area of the Mth segment at the time of subsequently writing the Mth parameter,
wherein the header information includes the number of segments included in each of the primary macroblock and the secondary macroblock and address offset information for calculating a start address of an area where the Mth parameter is to be written next.

3. The data storage flash memory management method according to claim 1, comprising the steps of:
when the number of segments included in each of the primary macroblock and the secondary macroblock is equal to or more than k+1, writing all or part of a value of an Mth parameter included in the k parameters to a segment other than first to kth segments in the active-system macroblock if there remains no writable area in an Mth segment to write the Mth parameter to the corresponding Mth segment in the active-system macroblock,
wherein address offset information included in header information of the Mth parameter includes information indicating a start address of the writable segment as an area where the Mth parameter is to be written next.

4. The data storage flash memory management method according to claim 3, comprising the steps of:
writing the Mth parameter from a start address of the Mth segment in the standby-system macroblock if there remains no unused segment in the active-system macroblock to write the Mth parameter;
after the step above, reading the latest values of parameters other than the Mth parameter from the active-system macroblock and writing the latest values to corresponding segments in the standby-system macroblock;
after the steps above, erasing data in all areas of the active-system macroblock; and
after the steps above, setting the standby-system macroblock to a new active-system macroblock and setting the active-system macroblock to a new standby-system macroblock.

5. The data storage flash memory management method according to claim 2, comprising the steps of:
reading the address offset information included in the header information from a top of the active-system macroblock at the time of writing the Mth parameter;
repeating a step for calculating a start address of an area where the Mth parameter is next updated and written based on the address offset information and determining whether the area is an area where data is already written or a blank area by reading data in the area, until the blank area is found; and
writing the Mth parameter to the found blank area.

6. The data storage flash memory management method according to claim 2, comprising the steps of:
reading the address offset information included in the header information from a top of the active-system macroblock at the time of reading the Mth parameter;
repeating a step for calculating a start address of an area where the Mth parameter is next updated and written based on the address offset information and determining whether the area is an area where data is already written or a blank area by reading data in the area, until the blank area is found; and
reading the Mth parameter written just before the found blank area, as the latest value of the Mth parameter.

7. The data storage flash memory management method according to claim 2, wherein the header information further includes segment identification information of a segment where the Mth parameter is written.

8. The data storage flash memory management method according to claim 7, wherein a conversion table for associating the segment identification information with an array name used by an application program is stored in the data storage flash memory.

9. The data storage flash memory management method according to claim 8, wherein the array name can be associated with the same segment identification information a plurality of times in the conversion table, the association of the array name with the segment identification information is invalidated by an even-numbered association, and the association of the array name with the segment identification information is invalidated by a next odd-numbered association.

10. A program for repeatedly updating and writing k varying parameters (k is a positive integer) to a flash memory and reading the latest data of the parameters and executed by a processor which can access the flash memory, the program comprising the steps of:
defining a primary macroblock and a secondary macroblock each having the same number of blocks as erase units in the flash memory, with one of the primary and secondary macroblocks as an active system and the other as a standby system;
defining k or more segments each having an equal memory capacity in the primary macroblock and defining k or more segments each having an equal memory capacity in the secondary macroblock;
one-to-one associating the k parameters with k segments of the k or more segments;
executing a write step for writing a parameter to a corresponding segment in an active-system macroblock in the flash memory; and
executing a read step for reading the latest value of the parameter from a corresponding segment in the active-system macroblock in the flash memory.

11. The program according to claim 10,
wherein an Mth parameter (M is a positive integer not more than k) included in the k parameters is written in order from a start address of a corresponding Mth segment in the active-system macroblock, with header information added to the Mth parameter,
wherein the header information includes the number of segments included in each of the primary macroblock and the secondary macroblock and address offset information indicating an offset to a start of an area where the Mth parameter is to be written next,
wherein the write step for writing the Mth parameter comprises a step of reading the address offset information included in the header from the start address of the Mth segment, repeating a step of calculating an address for storing next header information based on the address offset information and reading the next header information, until a blank area where header information is not stored is reached, and writing the Mth parameter with header information to the blank area, and
wherein the read step for reading the latest value of the Mth parameter comprises a step of reading the address offset information included in the header from the start address of the Mth segment, repeating a step of calculating an address for storing next header information based on the address offset information and reading the next header information, until a blank area where header information is not stored is reached, and reading the parameter with header information read just before the blank area is reached, as the latest value of the Mth parameter.

12. The program according to claim 11, wherein the number of segments included in each of the primary macroblock and the secondary macroblock is equal to or more than k+1, and the write step for writing the Mth parameter comprises a step of writing all or part of a value of the Mth parameter included in the k parameters to a segment other than first to kth segments in the active-system macroblock if there remains no writable area in the Mth segment to write the Mth parameter to the corresponding Mth segment in the active-system macroblock, and
wherein the address offset information included in the header information of the Mth parameter includes information for calculating a start address of the writable segment as an area where the Mth parameter is to be written next.

13. The program according to claim 12, comprising the steps of:
writing the Mth parameter from a start address of the Mth segment in the standby-system macroblock if there remains no unused segment in the active-system macroblock to write the Mth parameter;
after the step above, reading the latest values of parameters other than the Mth parameter from the active-system macroblock and writing the latest values to corresponding segments in the standby-system macroblock;
after the steps above, erasing data in all areas of the active-system macroblock; and
after the steps above, setting the standby-system macroblock to a new active-system macroblock and setting the active-system macroblock to a new standby-system macroblock.

14. The program according to claim 11, wherein the header information further includes segment identification information of a segment where the Mth parameter is written.

15. The program according to claim 14, comprising a step of storing a conversion table for associating the segment identification information with an array name used by an application program in the flash memory.

16. The program according to claim 15, comprising a step of allowing association of the array name with the same segment identification information a plurality of times in the conversion table, invalidating the association of the array name with the segment identification information by an even-numbered association, and validating the association of the array name with the segment identification information by a next odd-numbered association.
